(19) United States
(12) Patent Application Publication
(10) Pub. No.: US 2016/0071190 A1
(43) Pub. Date: Mar. 10, 2016

(54) MODIFYING ELECTRONIC ORDERS DURING A FULFILLMENT PROCESS

(71) Applicant: ORACLE INTERNATIONAL CORPORATION, Redwood Shores, CA (US)

(72) Inventors: Brian VOELZ, Minnetonka, MN (US); Rebecca MAIFELD, Brooklyn Park, MN (US); Steven GOOIJER, Maple Grove, MN (US); Neetu SINGH, Allahabad UP (IN)

(21) Appl. No.: 14/482,185

(22) Filed: Sep. 10, 2014

(51) Int. Cl. G06Q 30/06; G06Q 10/08

(52) U.S. Cl. CPC G06Q 30/0635; G06Q 10/087; G06Q 10/083

(57) ABSTRACT

Systems, methods, and other embodiments associated with modifying electronic orders during fulfillment are described. In one embodiment, a computing system includes order logic configured to receive a cancellation request to modify an electronic order that is for one or more items sold through an electronic commerce source. The cancellation request is a request from a customer to modify an ordered quantity of the one or more items according to a cancelled quantity indicated in the cancellation request. The computing system includes an update logic configured to update the electronic order by modifying fulfillment of the electronic order according to a status and the cancelled quantity. The status indicates progress in fulfilling the electronic order from inventory of the electronic commerce source.

### BACKGROUND

Electronic commerce (e-commerce) continues to become more prevalent among traditional retailers as a way to expand prospective business. Generally, retailers establish virtual stores in the form of websites that provide on-line shopping to a wider base of customers. However, e-commerce presents many unique difficulties.

For example, customers typically navigate an e-commerce website on their own. The customers electronically select items for purchase and finalize orders (that are electronically submitted) on their own and thus may make mistakes. For example, a customer may erroneously select an item, select an incorrect quantity of an item or simply change their mind about ordering an item. Accordingly, while the customer may review the order before finalizing and electronically submitting the order to the website, circumstances may still arise where the customer desires to cancel a part of the order or the whole order after the order is submitted for processing.

However, cancelling items from the order, especially once the order is being processed, can cause difficulties with properly fulfilling the order. Thus, retailers generally provide limited support for order cancellations and product returns become more likely.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a device associated with cancelling items from orders during fulfillment.

FIG. 2 illustrates one embodiment of a method associated with modifying quantities of items in an order during fulfillment.

FIG. 3 illustrates an embodiment of a computing system configured with the example systems and/or methods disclosed.

### DETAILED DESCRIPTION

Systems and methods are described herein associated with improving a granularity of how and when items can be cancelled from electronic orders during fulfillment of the electronic orders. In one embodiment, a system receives electronic orders through an e-commerce source such as a website via electronic communications over a communication network. After an order is received, a fulfillment process begins for fulfilling the order (e.g., locate items purchased from an in-store inventory, retrieve items, package items, and ship items to customer). In general, the system electronically tracks the order through the various stages of the fulfillment process.

If, at some point during the fulfillment process, the system receives a cancellation request to cancel selected items from the order, the system is configured to cancel the selected items depending on a current stage in the fulfillment process. In one embodiment, the system handles the cancellation request in different ways according to the status of the fulfillment process as tracked by the system. For example, the system determines which stage the order is at in the fulfillment process so that the cancellation request can be processed within a proper context.

The system may modify inventory records of a database, cause items to be physically returned to inventory by generating electronic reverse picking instructions or simply deny the cancellation request if, for example, the order is complete. In general, the system modifies how the order is fulfilled according to the status. In this way, orders can be partially or fully cancelled during the fulfillment process and inventory can be tracked accurately.

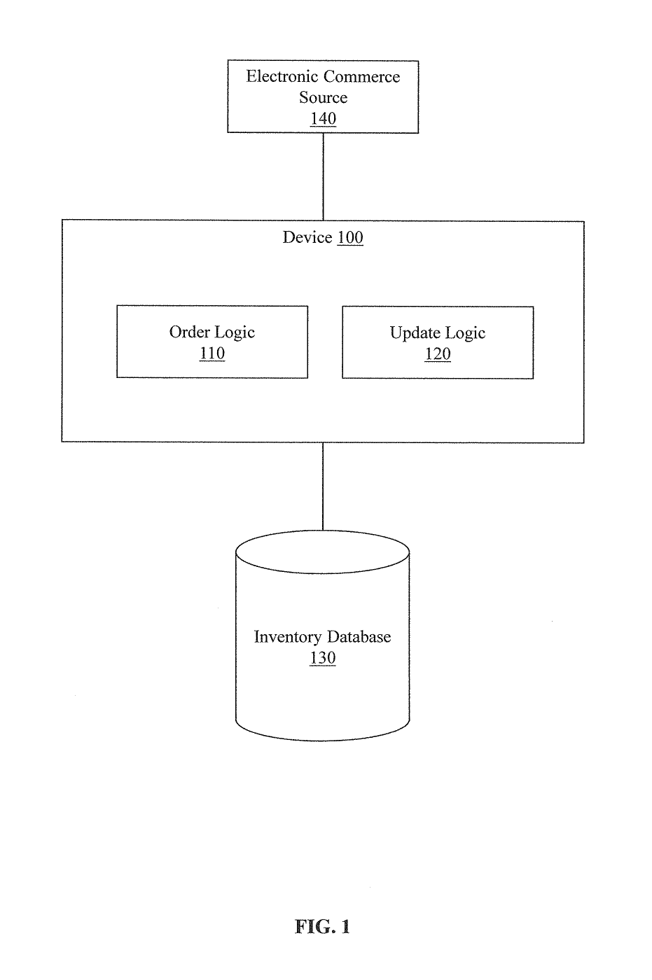

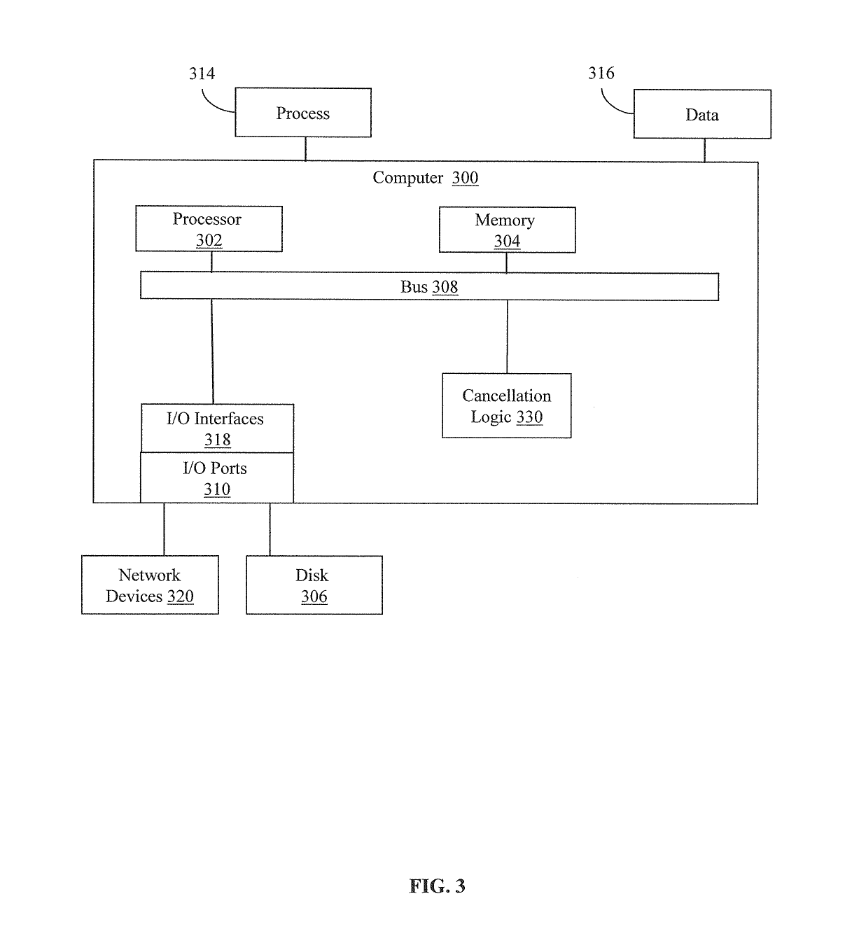

With reference to FIG. 1, one embodiment of a device 100 associated with handling how and when electronic orders can be cancelled during a fulfillment process is illustrated. In general, the device 100 improves the granularity of processing order cancellation requests. The device 100 includes order logic 110 and update logic 120. The order logic 110 is configured to receive electronic orders and other electronic communications from customers (e.g., cancellation requests) and electronically dispatch the orders for fulfillment from an inventory. Thus, in one embodiment, the order logic 110 is a processor or other computing device (e.g., computer 300 of FIG. 3) that is configured to receive orders and electronically dispatch the orders for fulfillment.

Additionally, the update logic 120 is configured to process cancellation requests by determining a current status of orders and electronically updating fulfillment according to the current status. Thus, in one embodiment, the update logic 120 is a processor or other computing device (e.g., computer 300 of FIG. 3) that is configured to process cancellation requests.

In one embodiment, the device 100 communicates with an inventory database 130 that includes records of the inventory (e.g., physical items that are in a store location or in a warehouse, products/materials in stock). For example, the inventory database 130 stores information about different items in the inventory. The information may include available inventory, reserved inventory, a status for each order, attributes of items and so on. Additionally, the items may be groceries (e.g., produce), electronics, clothing or any other consumer product.

In one embodiment, the device 100 is an inventory management system that is configured to manage the inventory for an electronic commerce source 140. The electronic commerce source 140 may be a website or other electronic media for providing commerce between customers and a retailer. Additionally, the electronic commerce source 140 may be associated with a retail store location. The retail store location is a physical retail store that shares the inventory with the electronic commerce source 140. Thus, the inventory may be an in-store inventory of the retail store location. Accordingly, the inventory may be on store shelves (in stock) and are available to customers at the retail store location. In one embodiment, online orders submitted through the electronic commerce source 140 are fulfilled from the in-store inventory of the retail store.

Because the inventory may be shared between the electronic commerce source 140 and the retail store location, efficiently managing the inventory and avoiding disparities in inventory that is reported as being available versus actually available inventory can be important. When disparities exist between available inventory and actual inventory as tracked by the inventory database 130, the electronic commerce source 140 may erroneously indicate that items are available (e.g., in stock, in inventory) when the items are actually not available (e.g., not in stock). Additionally, cancelled items may not get properly returned to shelves in the retail store location, which further complicates fulfilling orders from an in-store inventory. Thus, modifying fulfillment of orders to account for cancellations improves management of the in-store inventory.

The following is one example of how disparities between available inventory (reported by the database) and actual inventory arise. Suppose that a customer is shopping at the retail store location (inside the physical building) and selects an item from the inventory but has not yet checked out. In other words, the in-store customer takes (removes) an item off a store self and the customer continues shopping in the store. Also suppose that the item taken is the last item of its kind in the store. Thus, database records of the available inventory will indicate the item is still available (still physically on the shelf), however, it is not. Furthermore, suppose an on-line order is placed through the electronic commerce source 140 according to an available quantity of the item at a same time as the in-store customer selects the item from the shelf at the retail store location. In this example, the database inventory does not reflect what is actually present at the retail store location. Thus, when the order logic 110 electronically dispatches the on-line order to the retail store for fulfillment, in-store personnel will subsequently go to retrieve the item from the shelf, but the item will not be present. Thus the on-line order may need to be modified.

This situation presents a few options for the on-line customer and how to handle the on-line order. If there are multiple items in the on-line order, the customer or retailer may choose to continue with fulfillment for the remaining items, to cancel the whole on-line order, to cancel only a portion of the remaining items and so on. In general, many circumstances may exist where the customer or retailer desire to cancel part of the order or the whole order at various stages during the fulfillment process. To understand how these disparities may arise, consider how an electronic on-line order is fulfilled after being received from the electronic commerce source 140.

Fulfillment of an order begins when the order is received by the order logic 110 in response to a customer purchasing items via the electronic commerce source 140 and electronically submitting the order to confirm the purchase (e.g., pressing a submit button, etc.). In one embodiment, once the order is electronically received by the system, the order logic 110 initiates fulfillment either automatically or in response to a user (i.e., worker at the retail location) requesting, for example, a batch of new orders that need to be fulfilled. In either case, fulfillment of the order begins at some point after the original on- line purchase.

In general, fulfillment of the order includes a sequence of events that are electronically tracked by the order logic 110. For example, fulfillment of the order may include electronically reserving the ordered quantity from the inventory database 130, electronically generating a pick request to cause items to be collected from the retail store location, tracking when the order prepared for shipment and shipping the order.

The proceeding list should not be construed as a complete/exact list of the sequence of events but should be construed as an exemplary sequence of events for purposes of discussion. Different types of products and/or different types of companies/retailers will have different procedures and perform different actions to fulfill an order. In general, the order logic 110 is configured to electronically track the events of the fulfillment process and communicate with the various resources involved via electronic network messages (e.g., communicate with a warehouse, packaging facility, shipping facility, retail store location, etc.).

Because fulfillment of the order is a process that includes several different events, a status of the order changes and is thus electronically tracked by the order logic 110 as the order is fulfilled. For example, the status may indicate the order is not picked (not yet retrieved from a shelf), being picked, partially picked, fully picked, partially shipped, fully shipped, and so on. Additionally, each step in the sequence of events does not occur instantaneously but instead may occur with varying degrees of delay that depend on a specific implementation. Accordingly, the order logic 110 is configured to receive various electronic network communications from devices, users, and other systems involved in fulfilling the order to track the status.

Thus, depending on when a cancellation request is received during the fulfillment process, handling of the cancellation request will differ. The cancellation request is, for example, a communication that is generated from the electronic commerce source 140 when a customer desires to cancel items from an order. Generally, the cancellation request is an electronic request from a customer to modify an ordered quantity of one or more items in the order. The cancellation request may be generated in response to a notice to the customer that an ordered item is not available or is generated independently in response to actions by the customer through the electronic commerce source 140 at any point during fulfillment.

In one embodiment, the cancellation request includes a cancelled quantity, an order number, an item(s) to be cancelled and/or other instructions (e.g., substitute item). The cancelled quantity indicates, for example, an amount to cancel from the order of a single item or of multiple items. That is, the cancelled quantity may indicate cancelled amounts for multiple items.

For example, the cancelled quantity indicates to cancel one of a first item and three of a second item. In general, the cancelled quantity can specify to cancel different quantities for different items in the order. Additionally, in one example, the cancellation request may be a blanket cancellation that is for cancelling all items from the order.

As noted previously, depending on when during the fulfillment process the cancellation request is received, electronically processing the cancellation requests will differ.

Accordingly, the update logic 120 is configured to first determine the status of the order as electronically tracked by the order logic 110. In one embodiment, the update logic 120 is configured to query an electronic status report in the inventory database 130 to determine the status. In another embodiment, the update logic 120 is configured to maintain an electronic log of a status of each order. In either case, the update logic 120 determines the status of the order so that the cancellation request can be processed with regard to the fulfillment process for the order.

How the update logic 120 is configured to handle each different status will be discussed from a status that indicates the order was just received to a status that indicates the order has already been shipped. The various statuses are discussed subsequently under headings from A to F.

(A) Not Picked

The status of “not picked” indicates that the order has been electronically received but that no further processing has occurred. When an order is in the “not picked” state, initial intake processing has been performed but no physical selection of items from the inventory has yet occurred. In one embodiment, the device 100 performs initial intake by electronically reserving ordered quantities of items from records of the inventory in the inventory database 130.

Accordingly, the update logic 120 is configured to electronically return cancelled quantities indicated by the cancellation request from reserved to available inventory when the status indicates “not picked.” In this way, available quantities of the inventory in the inventory database 130 properly reflect cancelled quantities. Since no physical fulfillment for the order has yet occurred, the update logic 120 returns the cancelled quantities electronically from reserved to available inventory. Additionally, if the order is completely cancelled, then the update logic 120 also, for example, removes the order from a waiting queue.

(B) Being Picked

The status of “being picked” indicates that the order has begun the picking process of being selected from the inventory, but no items have been electronically scanned or electronically entered yet as having been selected/taken from the inventory at the retail store location. Accordingly, the update logic 120, for example, when validating picked items, may prompt a user that is picking the items about the cancellation request. That is, when a picked item is entered by providing a picked weight/quantity, an electronic prompt or other form of notification, notifies the user (in-store worker) of the cancellation request. In one embodiment, the user can then accept or reject the cancellation request. If the user accepts the cancellation request, the update logic 120 electronically adjusts the inventory. Additionally, if the user has picked any items, the user may return them to inventory upon accepting the cancellation request. However, if the cancellation request is rejected then the order continues to be fulfilled without regard to the cancellation request.

(C) Partially Picked

The status of “partially picked” indicates that a portion of the ordered quantity has physically been selected from the inventory. Accordingly, similar to the “being picked” status, the update logic 120 may electronically issue a prompt to a user that is picking the order to notify the user of the cancellation request. In one embodiment, the user can then accept or reject the cancellation request. If the cancellation request is rejected then the order continues to be fulfilled without regard to the cancellation request.

However, if the user accepts the cancellation request, the update logic 120 electronically adjusts the inventory by returning a reserved quantity that equals a cancelled quantity to records in the inventory database 130. Additionally, the update logic 120 electronically generates a reverse pick order that causes the physically picked items to be returned to the inventory. In one embodiment, the update logic 120 generates the reverse pick order only if cancelled quantities exceed non-picked quantities.

For example, suppose that an order specifies an ordered quantity of ten for an item and four of the item have already been picked. However, only two of the ordered quantity have been cancelled. Thus, the update logic 120 simply electronically reduces a remaining quantity to be picked from six to four and returns the cancelled quantity electronically from reserved inventory to available inventory in the inventory database 130.

However, if the cancelled quantity is eight, then the update logic 120 also generates a reverse pick order to have a user return two of the four that have been picked to the inventory. In this way, items can be selectively returned from a picked ordered to account for cancellations. Furthermore, in one embodiment, a reverse pick order may also indicate additional details such as items that are being requested as substitutes for cancelled items, a physical location of where to return cancelled items and so on. Additionally, the reverse pick order is, for example, an electronic communication that is sent via a network communication to a user that is picking or picked the order from the inventory. In this way, the user can be informed to return cancelled items to the inventory of the retail store location.

(D) Fully Picked

The status of “fully picked” indicates that items for the order have been physically selected and removed from the inventory but have not yet been shipped. Accordingly, because picking for the order has been completed, the update logic 120 may provide a prompt to a user to accept or reject the cancellation request. In one embodiment, the update logic 120 indicates to a user that an item has been cancelled when validating the item upon entry of the item after being picked. The update logic 120 may prompt the user to accept/reject the cancellation request by using a prompt or some other manner of entry (e.g., whether the user enters a picked amount). This is because returning some items to the inventory may not be possible. For example, if an item is cut to order or personalized then returning the item to the inventory may not be practical.

If the cancellation request is accepted, the update logic 120 returns the cancelled quantities to available inventory in the inventory database 130 while also generating a reverse pick request to have the cancelled quantities returned to physical inventory. In this way, the update logic 120 can modify the order according to the cancellation request after the order has been picked.

(E) Partially Shipped

The status of “partially shipped” indicates that at least part of the order has already been shipped. Accordingly, the update logic 120 processes the cancellation request depending on quantities of items from the order that have been shipped, picked, etc. For example, the update logic 120 may automatically deny a cancellation request for any part of the order that has already shipped. That is, if a cancelled quantity has already shipped, then the cancellation request may be automatically rejected and electronically cancelled. This is because the items are no longer within control of a retailer.

However, if, for example, the cancelled quantity is for an amount that is less than what has shipped, then the cancellation request may be accepted and the cancelled quantities electronically returned to inventory. Furthermore, the update logic 120 processes the cancellation request for any parts of the order that have not shipped according to previously described procedures related to a status of non-shipped items (e.g., “fully picked”).

(F) Fully Shipped/Complete

The status of “fully shipped/complete” indicates that the order has physically been fully picked from the inventory and has already been shipped to the customer. Accordingly, the update logic 120 is configured to automatically deny a cancellation request for an order with a status that indicates “shipped/complete.” The update logic 120 denies a cancellation request for an order with the status of complete since the order has already left the retail store location and the retailer no longer has the ability to modify the order.

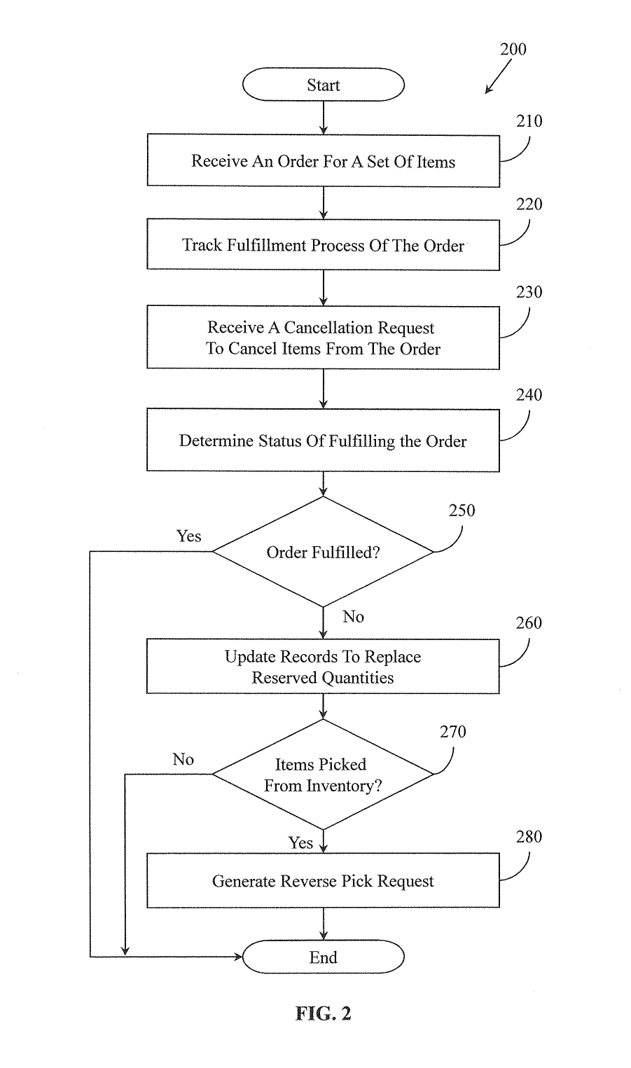

Additional aspects of processing cancellation requests during fulfillment of an order will be discussed with reference to FIG. 2. FIG. 2 illustrates a method 200 associated with modifying orders during fulfillment according to cancellation requests.

At 210, an order from a customer is received at, for example, a retail store location or other location from which the order will be fulfilled. In one embodiment, the order is initiated through an electronic commerce source such as a website or other electronic media. The retail store location is, for example, a physical location associated with the electronic commerce source. Accordingly, an inventory may be shared between the retail store location and the electronic commerce source.

In one embodiment, receiving the order initiates the fulfillment of the order by reserving the ordered quantity from the inventory. As discussed previously, fulfillment of an order includes several different events. However, fulfillment begins when the order is received, at 210, and ordered quantities are reserved from available inventory. In general, the ordered quantity is reserved and tracked in a database that maintains records of available inventory, reserved inventory, orders, ordered quantities and so on.

At 220, orders are electronically tracked during the fulfillment process. Of course, while tracking the fulfillment process is illustrated as a single element that occurs after receipt of the order, in general, tracking of the fulfillment process occurs continuously. In one embodiment, the order is electronically tracked according to different status messages that are received for each successive portion of the fulfillment process. That is, electric communications are provided in response to each action during the fulfillment process so that the order can be tracked and a status can be maintained and updated for the order at a central location.

At 230, a cancellation request is received. The cancellation request is a request to modify the order. In general, the cancellation request is an electronic request received across an electronic communications network and the cancellation request identifies quantities of items that are to be cancelled from the order. The cancellation request may also include additional information pertaining to the order such as an order identifier and so on.

Furthermore, in one embodiment, the cancellation request may be received in response to an out-of-stock notice sent to the customer. The out-of-stock notice is provided when the ordered quantity for an item is unavailable. In one embodiment, the out-stock notice may include a substitution of items for those that are out-of-stock (e.g., one brand for another). Thus, the cancellation request may be a notice to cancel the out-of-stock quantities, accept a proposed substitution, or to request a different substitution.

Additionally, in one embodiment, the cancellation request may be received at any point during fulfillment of the order. As previously mentioned, fulfillment includes several different stages that include initially receiving the order to finalizing and shipping the order. Since the cancellation request can be received at any time during fulfillment, how the cancellation request is processed will vary depending on a status of the order in the fulfillment process.

In still another embodiment, a cancellation request is generated in response to a user (e.g., retail operator) indicating that an item is unsuitable for shipment. That is, when an item that is in inventory and is being picked is discovered to be unsuitable (e.g., damaged) a cancellation request is generated so that the item can be cancelled from the order if no further replacement items are available. Accordingly, from the cancellation request a reverse pick request is automatically generated for the unsuitable item and the inventory can be adjusted appropriately.

At 240, the status of the order is determined. In one embodiment, the status of the order indicates a progression through fulfillment of the order. That is, the status indicates how far the order is from being completed and shipped. As previously noted, the status may indicate one of several different stages. In one embodiment, statuses include not picked, being picked, partially picked, fully picked, partially shipped or complete. Of course, the preceding list is provided for purposes of explanation only and in other embodiments may include different status indicators.

In addition to determining the status of the order at 240, in one embodiment, a user that is responsible for picking the order from physical inventory is prompted to accept or reject the cancellation request. In this way, if order specific items (e.g., items made specifically for the order) have already been processed, if the status is incorrect or if other circumstances that may influence the cancellation request exist, the user can properly handle the cancellation request.

At 250, if the status indicates that the order is fulfilled and complete, then the cancellation request is denied. The cancellation request may be denied at 250 because the order can no longer be modified since, for example, the order has already been shipped.

However, if the status indicates that the order has not been completed then, at 260, records of the inventory are updated to reflect returned inventory. Because records of the inventory are maintained in a database that is used to control orders from the electronic commerce source, ensuring that the records accurately reflect available inventory and do not have inaccuracies can help prevent orders for items that are not available and/or incorrectly reporting an item is out-of-stock.

At 270, if the status indicates that no items have been picked that are being cancelled then the method may end. However, if the status indicates that the order is fully picked, partially picked or in progress then a reverse pick request is generated at 280.

For example, if at least part of a quantity that is being cancelled has already been physically picked, then a reverse pick request is generated. The reverse pick request causes items in the order that have already been picked to be physically returned to inventory. In general, the reverse pick request may include cancelled quantities that are to be returned to inventory, a location for the returned items in the inventory, a process for returning cancelled items to the inventory (e.g., best ordered based on a physical layout of the inventory) and so on. In this way, the order is updated to modify fulfillment according to the status and the cancelled quantity.

Additionally, in one embodiment, a computing device is implemented with an executable algorithm that is configured to perform the method 200.

Computer Embodiment

FIG. 3 illustrates an example computing device that is configured and/or programmed with one or more of the example systems and methods described herein, and/or equivalents. The example computing device may be a computer 300 that includes a processor 302, a memory 304, and input/output ports 310 operably connected by a bus 308. In one example, the computer 300 may include cancellation logic 330 configured to facilitate processing cancellation requests during fulfillment of an order similar to order logic 110 and update logic 120 shown in FIG. 1. In different examples, the cancellation logic 330 may be implemented in hardware, a non-transitory computer-readable medium with stored instructions, firmware, and/or combinations thereof. While the cancellation logic 330 is illustrated as a hardware component attached to the bus 308, it is to be appreciated that in one example, the cancellation logic 330 could be implemented in the processor 302.

In one embodiment, cancellation logic 330 or the computer is a means (e.g., hardware, non-transitory computer-readable medium with stored executable instructions, firmware) for modifying fulfillment of an order to process cancellation requests.

The means may be implemented, for example, as an ASIC programmed to determine a status of an order and update fulfillment of the order according to the status. The means may also be implemented as stored computer executable instructions that are presented to computer 300 as data 316 that are temporarily stored in memory 304 and then executed by processor 302.

Cancellation logic 330 may also provide means (e.g., hardware, non-transitory computer-readable medium that stores executable instructions, firmware) for updating records of a database to properly reflect cancelled quantities from a cancellation request.

Generally describing an example configuration of the computer 300, the processor 302 may be a variety of various processors including dual microprocessor and other multi-processor architectures. A memory 304 may include volatile memory and/or non-volatile memory. Non-volatile memory may include, for example, ROM, PROM, and so on. Volatile memory may include, for example, RAM, SRAM, DRAM, and so on.

A storage disk 306 may be operably connected to the computer 300 via, for example, an input/output interface (e.g., card, device) 318 and an input/output port 310. The disk 306 may be, for example, a magnetic disk drive, a solid state disk drive, a floppy disk drive, a tape drive, a Zip drive, a flash memory card, a memory stick, and so on. Furthermore, the disk 306 may be a CD-ROM drive, a CD-R drive, a CD-RW drive, a DVD ROM, and so on. The memory 304 can store a process 314 and/or a data 316, for example. The disk 306 and/or the memory 304 can store an operating system that controls and allocates resources of the computer 300.

The computer 300 may interact with input/output devices via the i/o interfaces 318 and the input/output ports 310. Input/output devices may be, for example, a keyboard, a microphone, a pointing and selection device, cameras, video cards, displays, the disk 306, the network devices 320, and so on. The input/output ports 310 may include, for example, serial ports, parallel ports, and USB ports.

The computer 300 can operate in a network environment and thus may be connected to the network devices 320 via the i/o interfaces 318, and/or the i/o ports 310. Through the network devices 320, the computer 300 may interact with a network. Through the network, the computer 300 may be logically connected to remote computers. Networks with which the computer 300 may interact include, but are not limited to, a LAN, a WAN, and other networks.

In another embodiment, the described methods and/or their equivalents may be implemented with computer executable instructions. Thus, in one embodiment, a non-transitory computer storage medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, and other media from which a computer, a processor or other electronic device can function with. Each type of media, if selected for implementation in one embodiment, includes stored instructions of an algorithm configured to perform one or more of the disclosed and/or claimed functions.

“Logic”, as used herein, includes computer or electrical hardware, firmware, a non-transitory medium with stored instructions, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, all of which are configured to perform one or more of the disclosed functions. Logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A method, comprising:
tracking a fulfillment process that is being performed to fulfill an order of one or more items purchased through an electronic commerce source by maintaining a status of the order;
receiving a cancellation request to cancel selected items from the order, wherein the cancellation request is an electronic request from a customer to modify an ordered quantity of the one or more items according to a cancelled quantity indicated in the cancellation request;
determining a status of the order in the fulfillment process; and
updating the order by modifying the fulfillment process of the order according to the status and the cancelled quantity, wherein the status indicates progress in fulfilling the order from an inventory of the electronic commerce source.

2. The method of claim 1, wherein tracking the fulfillment process includes electronically updating the status in response to events during the fulfillment process, wherein receiving the cancellation request occurs during the fulfillment process of the order, wherein cancelling the selected items occurs during the fulfillment process of the order and includes selectively causing a portion of the order to be returned to the inventory according to the cancellation request, wherein the inventory is part of a retail store location, and wherein the fulfillment process for the order includes electronically processing the order, generating pick request to cause the order to be physically picked from the inventory, and completing the order for shipping.

3. The method of claim 1, wherein updating the order includes automatically updating electronic records of the inventory to return a reserved quantity of the one or more items to an available quantity in the records when the status indicates that the order has not been picked, and wherein the reserved quantity is an amount of the one or more items that is reserved from the inventory to account for the ordered quantity when the order is received and not yet picked from the inventory.

4. The method of claim 1, wherein updating the order includes denying the cancellation request when the status indicates that the order is complete by not modifying the fulfillment process of the order, wherein the status indicates that the order is: not picked, being pick, partially picked, fully picked, partially shipped or fully shipped.

5. The method of claim 1, wherein updating the order includes generating a reverse pick request that electronically prompts a user to accept or deny the cancellation request when the status indicates that the order is being picked, partially picked, fully picked or partially shipped, wherein a being picked status indicates that at least one item for the ordered has been picked from the inventory, wherein the reverse pick request indicates which items and quantities of the items from the order to return to available inventory, wherein generating the reverse pick request causes the cancelled quantity of the one or more items to be returned to the inventory as available quantities, and wherein an amount of the ordered quantity that exceeds the cancelled quantity remains in the order for the fulfillment process.

6. The method of claim 1, wherein updating the order includes generating a reverse pick request for returning physically picked items to the inventory and wherein the reverse pick request provides a process for returning the cancelled quantities to the inventory as available quantities.

7. The method of claim 1, further comprising:
receiving, at a retail location associated with the electronic commerce source, the order from the customer, wherein receiving the order electronically initiates the fulfillment process of the order by reserving the ordered quantity from the inventory.

8. A computing system, comprising:
order logic configured to receive a cancellation request to modify an electronic order that is for one or more items sold through an electronic commerce source, wherein the cancellation request is a request from a customer to modify an ordered quantity of the one or more items according to a cancelled quantity indicated in the cancellation request; and
update logic configured to update the electronic order by modifying fulfillment of the electronic order according to a status and the cancelled quantity, wherein the status indicates progress in fulfilling the electronic order from inventory of the electronic commerce source.

9. The computing system of claim 8, wherein the order logic is configured to receive the cancellation request occurs during fulfillment of the electronic order, wherein modifying fulfillment of the electronic order includes selectively returning a portion of the electronic order to the inventory according to the cancellation request, wherein the inventory is part of a retail store location, and wherein fulfillment of the electronic order includes processing, picking, and completing the order for shipping.

10. The computing system of claim 8, wherein the update logic is configured to update the electronic order by automatically updating records of the inventory to return a reserved quantity of the one or more items to an available quantity in the records when the status indicates that the electronic order has not been picked or when the cancelled quantity has been returned to the inventory from being picked and wherein the reserved quantity is an amount of the one or more items that is reserved from the inventory to account for the ordered quantity when the electronic order is received and not yet picked from the inventory.

11. The computing system of claim 8, wherein the update logic is configured deny the cancellation request when the status indicates that the electronic order is complete by not modifying fulfillment of the electronic order, wherein the status indicates that the electronic order is: not picked, being pick, partially picked, fully picked, partially shipped or fully shipped.

12. The computing system of claim 8, wherein the update logic is configured to update the electronic order by generating a reverse pick request that prompts a user to accept or deny the cancellation request when the status indicates that the electronic order is being picked, wherein a being picked status indicates that at least one item for the ordered has been picked from the inventory, wherein the reverse pick request indicates which items and quantities of the items from the electronic order to return to available inventory, wherein the update logic is configured to generate the reverse pick request to cause the cancelled quantity of the one or more items to be returned to the inventory as available quantities, and wherein an amount of the ordered quantity that exceeds the cancelled quantity remains in the electronic order for fulfillment.

13. The computing system of claim 8, wherein the update logic is configured to update the electronic order by generating a reverse pick request for returning physically picked items to the inventory, wherein the reverse pick request provides a process to a user for returning the cancelled quantities to the inventory as available quantities and wherein generating a reverse pick includes generating a reverse pick in response to a user indicating that an item is unsuitable for shipment.

14. The computing system of claim 8, wherein the order logic is configured to receive the electronic order from a network communication from the customer and to initiate the fulfillment of the electronic order by reserving the ordered quantity from the inventory, wherein the order logic is configured to electronically track the progress in fulfilling the electronic order, and wherein the order logic is configured to determine the status from records generated from electronically tracking the progress in fulfilling the electronic order.

15. A non-transitory computer storage medium storing instructions for execution by a device, the non-transitory computer storage medium comprising:
instructions configured to:
receive a cancellation request to modify an order that is for one or more items sold through an electronic commerce source, wherein the cancellation request is a request from a customer to modify an ordered quantity of the one or more items according to a cancelled quantity indicated in the cancellation request; and
update the order by modifying fulfillment of the order according to a status and the cancelled quantity, wherein the status indicates progress in fulfilling the order from inventory of the electronic commerce source, and wherein the inventory is part of a retail store location.

16. The non-transitory computer-storage medium of claim 15, wherein the instructions are configured to receive the cancellation request occurs during fulfillment of the order, wherein modifying fulfillment of the order includes selectively returning a portion of the order to the inventory according to the cancellation request, and wherein fulfillment of the order includes processing, picking, and completing the order for shipping.

17. The non-transitory computer-storage medium of claim 15, wherein the instructions are configured to update the order by automatically updating records of the inventory to return a reserved quantity of the one or more items to an available quantity in the records when the status indicates that the order has not been picked or when the cancelled quantity has been returned to the inventory from being picked and wherein the reserved quantity is an amount of the one or more items that is reserved from the inventory to account for the ordered quantity when the order is received and not yet picked from the inventory.

18. The non-transitory computer-readable medium of claim 15, wherein the instructions are configured deny the cancellation request when the status indicates that the order is complete by not modifying fulfillment of the order, wherein the status indicates that the order is: not picked, being pick, partially picked, fully picked, partially shipped or fully shipped.

19. The non-transitory computer-readable medium of claim 15, wherein the instructions are configured to update the order by generating a reverse pick request that prompts a user to accept or deny the cancellation request when the status indicates that the order is being picked, wherein a being picked, partially picked, fully picked, or partially shipped status indicates that at least one item for the ordered has been picked from the inventory, wherein the reverse pick request indicates which items and quantities of the items from the order to return to available inventory, wherein the instructions are configured to generate the reverse pick request to cause the cancelled quantity of the one or more items to be returned to the inventory as available quantities, and wherein an amount of the ordered quantity that exceeds the cancelled quantity remains in the order for fulfillment.

20. The non-transitory computer-readable medium of claim 15, wherein the instructions are configured to receive the order from the customer and to initiate the fulfillment of the order by reserving the ordered quantity from the inventory.
